(19) United States
(12) Patent Application Publication
(10) Pub. No.: US 2008/0249862 A1
(43) Pub. Date: Oct. 9, 2008

(54) Business services program embodying a reinvestment

(75) Inventors: Richard M. Roth, Miami, FL (US); Mark J. Mechanic, Dania Beach, FL (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: IGT Media Holdings, Inc., Miami, FL (US)

(21) Appl. No.: 11/784,441

(22) Filed: Apr. 6, 2007

(51) Int. Cl. G06Q 30/00

(52) U.S. Cl. 705/14

(57) ABSTRACT

A method which is a two-way transaction between a media services provider (MSP) and a Client, the MSP making an investment with the Client in an amount based upon the purchase of advertising services from the MSP by the Client. The Client provides the MSP with its products and/or services in return for the MSP's investment, which the MSP remarkets Client's products and/or services to recoup its investment and earn a profit, at no cost to the Client. The method may also be employed between a provider (P) and a Client wherein the Client purchases either goods or both goods and services through P, P then reinvesting in the Client's business, and the Client providing its products and/or services to P who remarkets the Client's products and/or services at no cost to the Client, as described in the MSP/Client example, set forth above.

### FIELD OF INVENTION

The present invention relates to providing business services, such as advertising services, for Clients and more particularly to advertising services for Clients which provides for investing a portion of the amount, obtained from the Client's for such services, into the Client's business in the form of purchasing the Client's products and/or services.

### BACKGROUND

The advertising industry is set forth as one industry example in order to appreciate the uniqueness of the present invention. Traditionally, media buying in the advertising industry has been a commodity-based business. For example, there are hundreds of companies in a given market selling advertising, printing and premiums to Clients (i.e., advertisers) with the essential difference being the price the advertising agency or media buying service charges the Client. An advertising spot during a highly prized television broadcast such as, for example, a championship football game, provides exactly the same result for the Client regardless of whether the spot is purchased from advertising agency “A” or “B”. Such products are commodities and these commodity-based products are typically market driven. In addition, advertising agencies or media buying services whose activities are typically based on a commission, have a conflict between their goal and the goals of the Client in that the more the Client pays, the more the agency earns.

As of the present date, services provided by an advertising agency or media buying service lack any opportunity for the Client to leverage such purchases into quantifiable new sales.

### SUMMARY

The present invention is characterized by providing a program offered by a broad variety of entities such as, but not limited to, advertising agencies and media buying services in which the Client obtaining such products and/or services directly profits from their advertising purchases or purchased products in a unique manner. Implicitly, instead of providing a one-way transaction, the entity, such as an advertising agency or media buying service or other like entity, hereinafter referred to as a media services provider (MSP), converts the purchase of advertising, printing and premiums on behalf of the Client into a two-way transaction in which the MSP purchases a significant percentage of the Client's products and/or services based on the cost of advertising, printing and/or premiums purchased by the Client from the MSP. This unique approach guarantees additional sales to the Client and further provides free marketing of its products at no cost to the client as an added benefit, since the MSP undertakes sales of the products and or services purchased from the Client, which enables the MSP to make back its reinvestment cost and earn a profit.

This technique constitutes a true partnership that is quantifiable in each and every transaction wherein the MSP immediately quantifies a portion of the Client's advertising expenditures through the MSP's purchases of the Client's product/services. The MSP completely removes the Client's acquisition cost on products and/or services purchased by the MSP from the Client, due to the MSP taking on the cost of marketing the purchased products and/or services, and further provides a quick and effective technique for bolstering the client's sales without any additional cost whatsoever to the Client.

As another example, which serves a further evidence of the broad application of the present invention to a wide variety of business/industries, a product/service provider (P) obtains an order from a Client, places the Client's order with a third party at a price agreed upon by the P and the Client and invests a portion of the purchase price for the order with the Client and subsequently obtains the Client's products and/or services in return for the investment prepaid to the Client. The P remarkets the Client's products/services to a customer base typically different from that of the Client, thus broadening the Client's customer base at no expense to the Client. In addition, P's reinvestment in the Client is immediately available for use by the Client.

### BRIEF DESCRIPTION OF THE DRAWING(S)

A detailed description of the invention will be set forth below in connection with the following Figures wherein like elements are designated by like numerals and, wherein;

FIGS. 1 through 3 are flow charts useful in explaining different embodiments of the architectural structure of the services provided according to the present invention.

### DETAILED DESCRIPTION OF THE PREFERRED EMBODIMENT(S)

Definitions of terms which are used throughout the description of the present invention are set forth herein in order to better understand the invention and its embodiments which include, among others, the following:

Definitions

Advertising Agency: also called Advertising Services Industry, Ad Agencies, Public Relations Firms, PR Firms, and Advertising and Marketing Industry. Establishments primarily engaged in creating advertising campaigns and placing such advertising in periodicals, newspapers, radio and television, and/or other media. These establishments are organized to provide a full range of services, (i.e. through in-house capabilities or subcontracting), including advice, creative services, account management, production of advertising material, media planning, and buying (i.e., placing advertising).

Client: also called Account, Advertiser. Manufacturer, owner, or provider of a product or service who desirers to advertise that product or service utilizing the help of a qualified specialist. The Client is the customer for whom the advertising agency or Media Buying Service works.

Media Buying Service: Comprises businesses primarily engaged in purchasing advertising time or space from media outlets and reselling it to advertising agencies or individual companies directly (Clients). In this process Media Buying Services generally have to liaise with media representative companies, which are contracted by media owners/operators to sell advertising on their behalf. The demand for the media buyers' industry services is directly related to the overall aggregate level of advertising expenditures by their Clients (including, under agreement from a number of advertising agencies and individual businesses), and which is used as leverage in negotiations with media owners and media representatives to obtain the best advertising rates and placements (in terms of both impact and reach against the agreed target audience) on their Clients' behalf.

Advertising: also called Media. Channels of communication that serve many diverse functions, such as offering a variety of entertainment with either mass or specialized appeal, communicating news and information, or displaying advertising messages. The media carry the advertisers' messages and serve as the vital link between the seller of a product or service and the consumer. Available types of media include print, electronic, out-of-home, Internet, and direct mail. Print usually refers to newspapers and magazines but also includes directories, school and church yearbooks handbills and newsletters, and programs at sporting events and theater presentations. Electronic media are usually referred to as broadcast media, or radio and television, including cable. Out-of-home media are designed almost exclusively to serve only an advertising function, and include, but are not limited to, billboards, transit advertising, and posters in public places such as stadiums, airports, and train stations, bus shelter, benches, as well flying banners (banners towed by airplanes) and skywriting. Internet media includes advertising banners on web sites, promotional online partnerships, emails campaigns and the purchasing of key words on search engines. Direct-mail media are advertisements that are mailed directly to prospects. As technology advances, new forms of media are being discovered every day, such as movie-house advertising, cell phone text messaging, and special automatic telephone devices with prerecorded advertising messages. Any single form of communication is known as a medium.

Printing: means of producing reproductions of written material or images in multiple copies. There are four traditional types of printing: relief printing, intaglio, lithography, and screen process printing.

Premium: Special items, bonus, or award offered free or at a nominal price as an incentive to induce a target market to purchase or obtain for trial a product or service. Advertisers use premiums to attract consumers who would not normally buy a product or service, or to encourage more frequent buying by those already buying the product. In addition, premiums are used to introduce new products, provide extra appeal in special sales events, meet competitive prices, provide copy appeal, promote larger size units, and excite a company's sales force. Newspapers, magazines, radio broadcasts, packages, store displays, outdoor advertising, direct-mail, and package inserts are frequently used to promote premiums. Many advertisers believe that the most effective premium is the one that is closely related to the type of product offered. For example, advertisers frequently imprint their name on their premium to reinforce the relationship between themselves and the premium.

Commodity: A basic good used in commerce that is interchangeable with other commodities of the same type. The quality of a given commodity may differ slightly, but it is essentially uniform across producers. The basic idea is that there is little differentiation between a commodity coming from one producer and the same commodity from another producer—a commercial on a television station is the same product, regardless of the agency selling the product (or service)

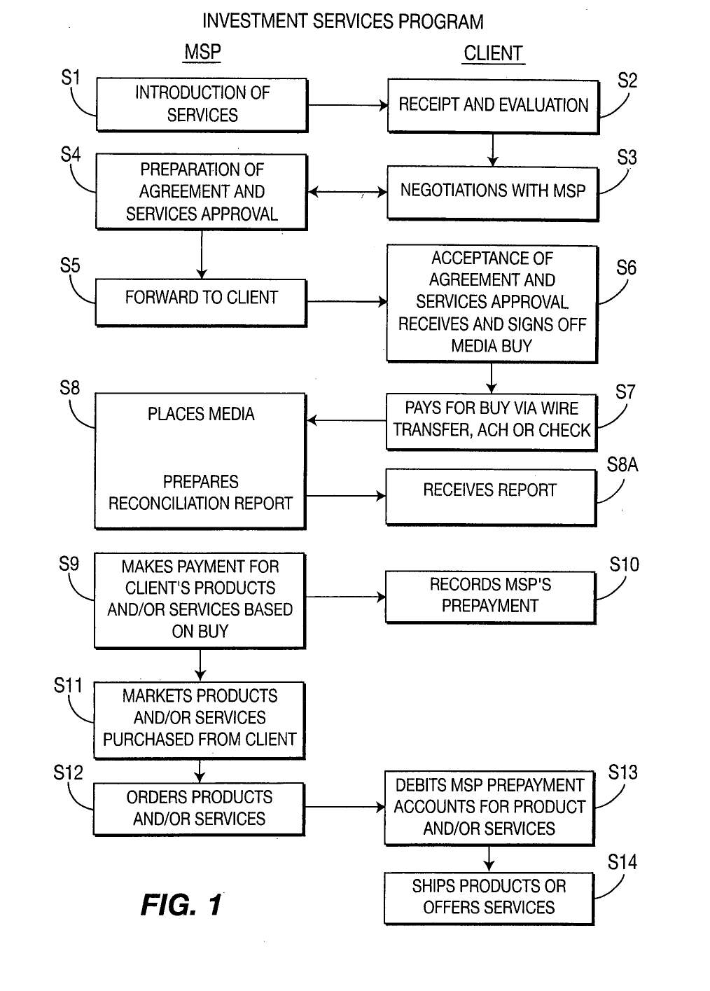

Making reference to FIG. 1 which shows the interaction between an MSP and a Client, the MSP makes contact with a potential Client, at step S1, which may occur in any one of a variety of approaches. For example, the potential Client may become aware of the unique investment services offered by the MSP through word-of-mouth or through efforts undertaken to research such entities and their range of services for the purpose of selecting such an entity, such as an MSP for general representation or for a particular advertising campaign or series of campaigns. Alternatively, the MSP or like entity may advertise its services, in much the same way that many Clients advertise their products and services i.e., through direct mail advertising, through various media, etc. As another alternative, the agency may directly contact potential Clients and provide a presentation of its unique services through the use of sales representatives who may either be employees or independent contractors.

The potential Client, at step S2, upon favorable reaction to the information obtained through step S1, provides the MSP, at step S2, with historical media information regarding the past history of the nature of its advertising and the advertising channels of communication utilized by the Client as well as the objectives sought by the Client, both broad and specific in nature, in either seeking a new MSP or launching a new campaign. Client and MSP, respectively, at steps S3 and S4, negotiate an understanding resulting in an agreement, the MSP analyzing the information obtained from the Client to craft a contract based on its analysis. The contract is customized in accordance with the nature of the Client's business and its objectives and desires with regard to the particular advertising campaign. The agreement sets forth the mutual obligations and responsibilities of the parties and identifies the Client's media availability guidelines and request for the approval of the contracted media such as TV, radio, magazines, etc., and a list of the products and/or services the MSP agrees to purchase from the Client. Products and/or services may either be currently available or be provided by the Client at a future agreed-upon date or on an as-made-available basis wherein the agreed-upon amount is provided over a given span of time.

The Client's major obligation is the agreement to a specific amount for the advertising campaign based on the approved media availability guidelines and media approved by the Client as well as the type and amount of media and the price of such media to the Client, at the time the Client is ready to proceed with the media program. As set forth above, media may for example, include but not be limited to at least one or a combination of one or more of the following, typically including, but not limited to, spot television, cable television and radio time, magazine, out-of-home advertising, premiums and printed matter. The agreement is forwarded to the client at step S5 and the Client accepts the agreement and the agreed-upon media buy, at S6.

The Client pays the MSP by the agreed-upon technique, such as check, money order, credit card, Automated Check Handling (ACH) and wire transfer, for example, at S7.

The MSP, at S8 places the media buy and follows up the buy with a reconciliation report wherein the MSP provides a media proof of purchase report to Client at S8A, which includes affidavits attesting to placements of TV and radio spots. In the case of magazines and other printed matter, copies or the like may be provided. In the case of out-of-home advertising, photos or videos of the billboards, etc. may be provided.

At step S9 MSP makes a cash payment to Client which is an agreed-upon portion of the cost of the MSP's services performed on behalf of Client. The MSP agrees to purchase product and/or services from the Client which is a dollar amount based on a significant percent of the amount the Client agrees to pay the agency for each dollar of media the agency agrees to purchase. As one example, the MSP may agree to purchase for cash, gift cards at 100% of face value equal to a given percentage of all media dollars contracted for by the Client. The MSP works in cooperation with the Client and/or the Client's agency, which may continue all responsibility for planning while providing the MSP with buying specifications and pricing for any media designated by the Client and placed by the MSP. All creative aspects typically remain with Client and/or its agency, but may be modified upon mutual agreement of the MSP and the Client. The MSP places the media based upon the Client's planned and budgeted rates.

At step S10, the Client creates an account recording the MSP's prepayment to Client.

In the example of gift cards, purchases by the MSP are mutually agreed upon between the MSP and the Client, with the understanding that the MSP does not interfere with the Client's existing customer base and with the objective of driving new customers to do business with the Client. As an alternative, the MSP and Client may create a remarketing plan which incorporates the Client's existing customer base in an attempt to provide the customer with additional value and/or increase the per customer spend to the Client, but without any further cost to the Client for such remarketing.

The MSP markets the Client's services/products, at S11. Some of the approaches for remarketing may include gift cards to the MSP's client base which may include, for example, automobile dealerships, Real Estate, Real Estate developers, Sales Organizations, Non-Profits, Charities, Manufacturers and Realtors which utilize gift cards as a promotional or fundraising tool.

In an example where the Client is a grocery store chain, the promotion may take any one of the following forms, for example:

a) “Sale on the XYZ cruise line during the month of May and you will automatically be entered to win a year worth of groceries.”

b) “Sell the most ABC Products for the year and win free groceries for a year.”

c) “All sales people doubling their sales goal during the present sales campaign win X dollars in groceries.”

d) “Be the first one-hundred (100) to purchase a (condo, car, or the like) and receive free groceries for a year.”

e) “Come in to any of our stores and register to win free groceries for a year.”

The remarketing may be by way of media promotions, wherein gift cards are remarketed to the MSP's media partners and can be utilized in both on air and as part of their Client promotions, such as:

a) “All contest winners of radio station ABC during the month of May will be entered into a grand prize drawing for free groceries for a year.”

b) “Station ABCD is giving away X dollars (or X premiums) every day during the month of May.”

MSP orders products/services from the Client at step S12. In the case of an immediate purchase, the MSP orders the products and/or services in bulk. Alternatively, the MSP may place an order for products and/or services to be delivered over a given time span, or may order a portion of the total agreed-upon amount, as needed by the MSP. The Client agrees to make the products and/or services available without any time limits.

Payments to the Client by the MSP at step S9 and recorded at step S10 are made shortly and a set time after the Client has paid MSP (see step S7), providing the Client with an extremely prompt reinvestment which can be put to use in any manner by the Client and is totally under the Client's control. In cases where the Client makes partial payments in lieu of one up-front payment, the MSP submits to the Client a set percentage of the partial payment received from the Client.

As set forth, at S11, MSP markets the products and/or services as per some of the examples set forth above and, at step S12, orders products and/or services in bulk or individually, responsive to MSP's marketing efforts. The Client, at step S13 debits the MSP's prepayment account for purchases made by MSP and ships products or provides services to the MSP at S14.

The reinvestment percentages provided by the MSP to the Client may vary with regard to the media type. For example, the percentage of reinvestment for spot TV, cable TV and radio advertising may be greater (or less) than the percentage of reinvestment for magazines and out-of-home advertising. The reinvestment payments are made directly from the MSP to the Client typically on the order of seven days from receipt of the media advertising funds from the Client.

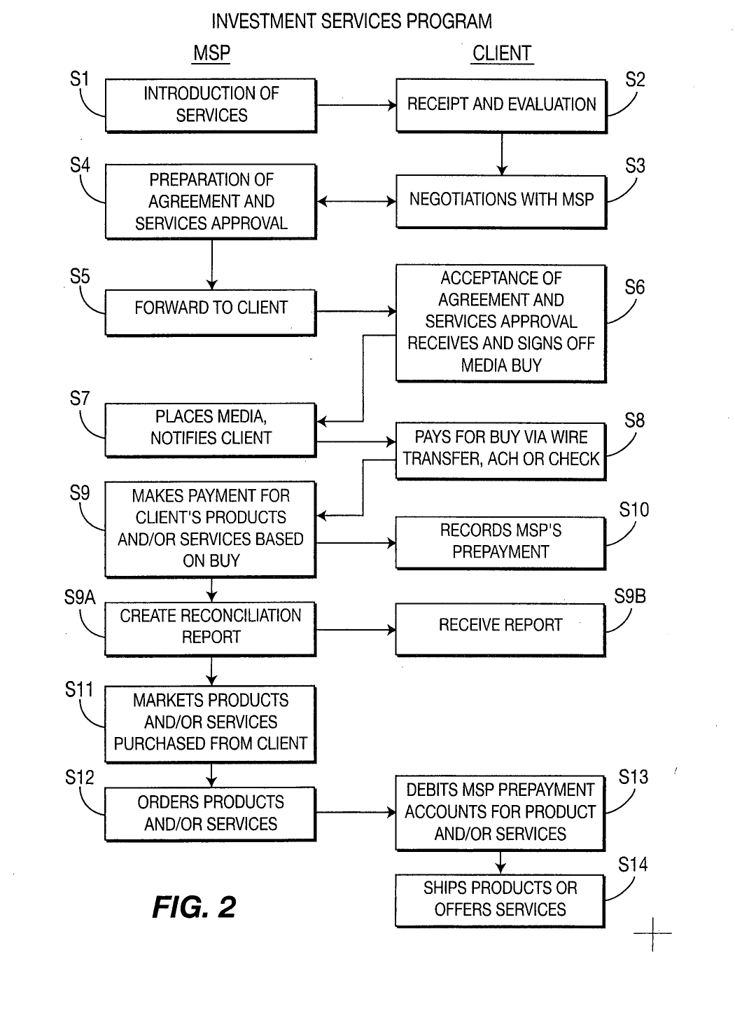

FIG. 2 shows another embodiment wherein steps S1-S6 are the same as shown in FIG. 1. At step S6, the Client notifies the MSP of the sign off and the MSP at S7, places the media, notifying the Client and, at S8, the Client pays the MSP for the buy and at S9 the MSP makes the reinvestment responsive to step S8, the Client recording the reinvestment at S10.

In a manner similar to that described in the embodiment of FIG. 1, MSP creates a reconciliation report at S9A and sends the report to the Client, at S9B. The remaining steps S11-S14 are the same as steps S11-S14 of FIG. 1.

All purchases of product by the MSP (see step S11) are made at prices agreed upon between MSP and the Client and, for retail Clients, are made at retail prices and at the same cost they are offered to the public. In the case of wholesale Clients, purchases are made at wholesale prices and at the same cost they are offered to other wholesalers or distributors who typically obtain the Client's products/services.

Further advantages gained by the Client using the unique methods described herein, in addition to those set forth above, include use by the MSP of the MSP's own sales techniques employed in the sales of its own products or products of third parties through its advertising of products other than those of the Client sold and/or promoted by the MSP. For example, the MSP may use newsletters or other periodicals in which the MSP advertises the products and services of its other clients and for which there is no additional charge or cost to the Client. The MSP typically has a large client base to which it directs its products and services and there is a great likelihood that at least a significant part of this customer base may be different from the Client's customer base, thereby enhancing the overall customer base of the Client.

Regarding the purchases made by the MSP, as was mentioned above, the nature of such purchases is typically determined according to the nature of the Client's business or specific advertising campaign. For example, purchases may include, among others, clothing and accessories at retail prices wherein the type of clothing and accessories is determined by the Client and, upon negotiation, may include excess and overstocked inventories. All remarketing conducted by the MSP is performed in accordance with the mutual understanding that MSP does not interfere with the Client's existing customer base and with the objective of driving new customers to do business with the Client.

As an alternative, the MSP and Client may create a remarketing plan which incorporates the Client's existing customer base in a n attempt to provide the customer with additional value and/or increase the per customer spend to the Client, but without any further cost to the Client for such remarketing.

Gift cards offered by the MSP in the MSP's advertising and sales campaign to market Client's product typically provide the recipient of the gift card with the opportunity to purchase a gift in the form of merchandise/services offered by the Client. Promotions undertaken by the MSP are often directed to segments of the public which are typically outside of the Client's core customer group and are performed, for example, by utilizing targeted mailings to MSP customers that do not meet the Client's customer profile and/or are outside of the Client's media market area. The remarketing techniques employed by the MSP to promote the Client's products as set forth above are by no means exhaustive and are typically customized according to the Client's industry and/or product line.

As further examples, the products/services provided by the Client may include restaurants services, moving and storage services, dry cleaning services, hotel and resort services as well as all types of travel and entertainment services, to name just a few.

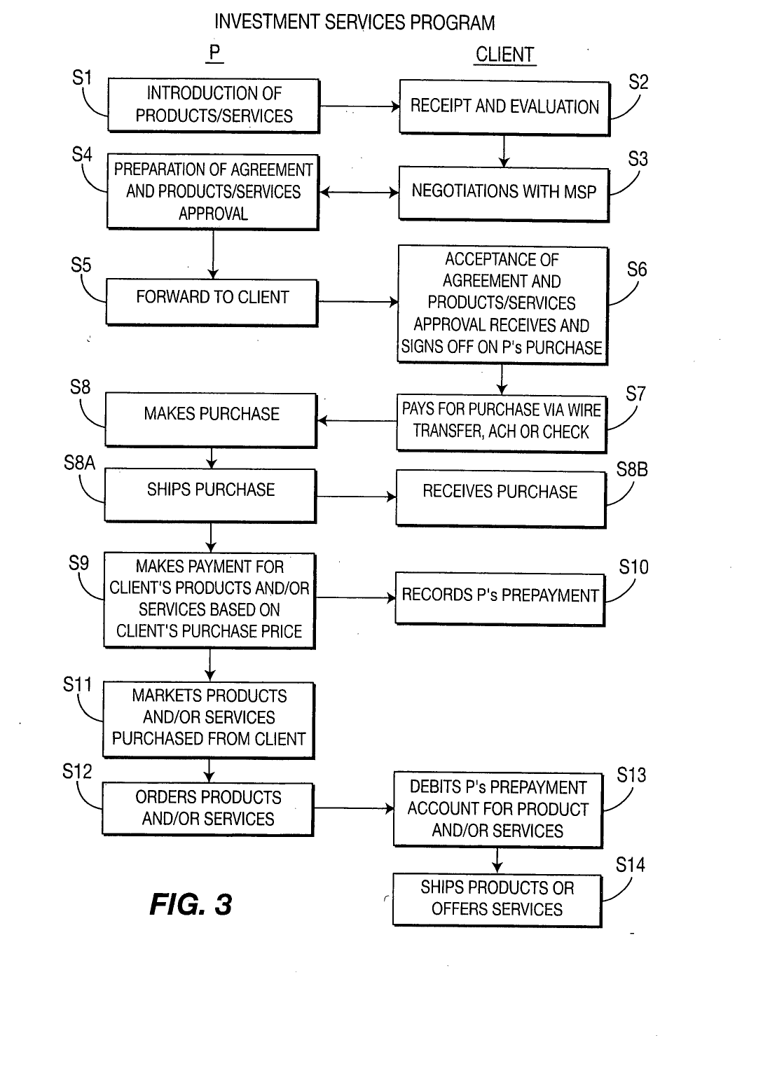

FIG. 3 is another embodiment showing the interaction between a provider (P) and a Client. P makes contact with a potential Client, at step S1, which may occur in any one of a variety of approaches as described above. The potential Client, at step S2, upon favorable reaction to the information obtained through step S1, provides the P, at step S2, with historical media information regarding the past history of the nature of purchases utilized by the Client as well as the objectives sought by the Client, both broad and specific in nature, in seeking a new P. Client and P, respectively, at steps S3 and S4, negotiate an understanding resulting in an agreement, P analyzing the information obtained from the Client to craft a contract based on P's analysis. The contract is customized in accordance with the nature of the Client's business needs and its objectives and desires with regard to the particular product and/or service. As a concrete example, it is assumed that Client wants to purchase softgoods, such as t-shirts, sweatsuits or the like. The agreement sets forth the mutual obligations and responsibilities of the parties and identifies the Client's guidelines and request for the approval of the contracted goods/services, as well as a list of the products and/or services P agrees to purchase from the Client, which may, for example, be the Client's gift cards or which P may offer outright or in the form of giftcards. The agreed-upon products and/or services may either be currently available or be provided by the Client at a future agreed-upon date or on an as-made-available basis wherein the agreed-upon amount is provided over a given span of time.

The Client's major obligation is the agreement to a specific amount for the products ordered and approved by the Client, at the time the Client is ready to proceed with the purchase program. The agreement is forwarded to the client at step S5 and the Client accepts the agreement and the agreed-upon purchase price, at S6.

The Client pays P by an agreed-upon technique, such as wire transfer, check or (ACH), for example, at S7.

P, at S8 makes the purchase and, at step S8A ships the purchased goods/services to Client who receives the goods/services at S8B. At S9, P makes a cash payment to Client which is an agreed-upon portion of the cost of the products/services provided by P to the Client. P agrees to purchase product and/or services from the Client which is a dollar amount based on a significant percent of the amount the Client paid for the purchase made by P on behalf of the Client. As one example, P may agree to purchase for cash, gift cards at 100% of face value equal to a given percentage of the purchase made at step S8.

A step S10, the Client creates an account recording P's prepayment to Client.

In the example of gift cards, purchases by P are mutually agreed upon between P and the Client, typically with the understanding that the P does not interfere with the Client's existing customer base and with the objective of driving new customers to do business with the Client.

As an alternative, the MSP and Client may create a remarketing plan which incorporates the Client's existing customer base in a n attempt to provide the customer with additional value and/or increase the per customer spend to the Client, but without any further cost to the Client for such remarketing.

P markets the Client's services/products, at S11. Some of the approaches for remarketing may include any one of the examples set forth above regarding FIG. 1.

The remarketing may be by way of media promotions, wherein gift cards are remarketed to P's media partners and can be utilized in both on air and as part of their Client promotions, as set forth above.

P orders products/services from the Client at step S12. In the case of an immediate, single purchase P orders the products and/or services in bulk. Alternatively, P may place an order for products and/or services to be delivered over a given time span, or may order a portion of the total agreed-upon amount, as needed by P. The Client agrees to make the products and/or services available without any time limits.

Payments made to the Client by P at step S9 and recorded at step S10 are made at a short and a set time after the Client has paid P (see step S7), providing the Client with an extremely prompt reinvestment which can be put to use in any manner by the Client and is totally under the Client's control. In cases where the Client makes partial payments in lieu of one up-front payment, P submits to the Client a set percentage of the partial payment received from the Client.

As set forth, at S11, P remarkets the products and/or services obtained from the Client as per some of the examples set forth above and, at step S12, orders products and/or services in bulk or individually, responsive to P's remarketing efforts. The Client, at step S13 debits the MSP's prepayment account for purchases made by MSP and ships products provides services to the MSP at S14.

What is claimed is:

1. A method of providing services related to advertising, comprising:
a media placement provider (MSP):
a) offering to place media in return for an agreed upon amount to be paid to MSP by the Client; and
b) placing the media in accordance with Client's approved list;
the Client:
c) providing the MSP the agreed upon amount per step (a);
the MSP:
d) investing a given portion of the agreed upon amount with the Client;
the Client;
e) setting up an account on behalf of said MSP for the agreed upon amount per step (d);
the MSP:
f) remarketing at least one of Client's products and/or services; and
g) ordering at least one of Client's products and/or services from Client;
the Client:
h) debiting the MSP account by an amount of the MSP's order.

2. The method of claim 1, wherein step (a) further comprises:
purchasing at least one of spot television (TV), cable TV and radio time on behalf of Client.

3. The method of claim 1 wherein step (a) further comprises:
purchasing at least one of magazine and out-of-home advertising on behalf of Client.

4. The method of claim 3 wherein out-of-home advertising comprises advertising other than TV, radio and magazine and which is seen out of the home.

5. The method of claim 4 wherein advertising seen out of the home includes
at least one of billboards, advertising on vehicles, bus shelters, public benches, sandwich boards, product packaging advertising products other than the contents of the packaging, banners pulled by airplanes, hot-air balloons and lighter-than-air craft and sky writing, printed matter and premiums.

6. The method of claim 1 wherein step (b) further comprises the Client exclusively controlling the media selected and the allocations of the selected media.

7. The method of claim 1 wherein step (c) further comprises paying the MSP the agreed upon amount in full.

8. The method of claim 1 wherein step (c) further comprises paying the MSP the agreed upon amount in a series of partial payments.

9. The method of claim 8 wherein step (d) further comprises:
investing said given portion in partial investments, each partial investment being a given portion of each of Client's partial payments.

10. The method of claim 1 wherein step (b) further comprises:
providing the Client with proof of performance.

11. The method of claim 10 wherein proof of performance comprises:
providing the Client with an affidavit attesting to performance.

12. The method of claim 10 wherein proof of performance comprises:
providing Client with copies of magazine advertisements confirming placement of the agreed-upon advertising.

13. The method of claim 10 wherein proof of performance comprises:
providing Client with at least one of photographs and video confirming placement of out-of home advertising.

14. The method of claim 13 wherein providing one of photographs and video further comprises providing the starting date and the length of time the advertising is on display.

15. The method of claim 1 wherein step (a) further comprises the MSP cooperating with at least one of an advertising agency and a media buying house designated by Client or Client directly in placing media.

16. The method of claim 1 wherein step (f) further comprises the MSP engaging in remarketing activities which are preferably outside of with Client's typical marketing activities.

17. The method of claim 1 wherein step (f) further comprises the MSP engaging in remarketing activities which are preferably outside of Client's normal sales territory.

18. The method of claim 1 wherein step (f) further comprises the MSP remarketing the Client's product and/or services to the MSP's Client base.

19. The method of claim 1 wherein step (f) further comprises remarketing the Clients products and/or services by means of at least one of a gift card and a gift certificate redeemable for the Client's products and/or services.

20. The method of claim 19 wherein the MSP provide its own gift cards.

21. The method of claim 19 wherein the MSP obtains the gift cards from the Client.

22. The method of claim 1 wherein step (g) further comprises the MSP obtaining Client's products in bulk.

23. The method of claim 1 wherein step (g) further comprises the MSP agrees to accept one of excess inventories and overstocked inventories from the Client.

24. The method of claim 1 wherein step (g) further comprises the MSP paying Client's retail prices for Client's products and/or services ordered from the Client.

25. The method of claim 1 wherein step (d) further comprises the investment being completely in legal tender.

26. The method of claim 1 wherein the legal tender is US dollars.

27. The method of claim 1 wherein the legal tender is any currency which has an exchange rate with the US dollars posted on a daily basis.

28. The method of claim 1 wherein step (c) further comprises the Client paying the MSP by at least one of check, money order, credit card Automated Check Handling (ACH) and wire transfer.

29. The method of claim 1 wherein step (d) further comprises the Client paying the MSP by at least one of check, money order, credit card, Automated Check Handling (ACH) and wire transfer.

30. The method of claim 1 further comprising:
(i) shipping products ordered by the MSP to the MSP.

31. The method of claim 1 wherein step (g) further comprises the MSP paying Client's wholesale prices for Client's products and/or services ordered from the Client.

32. The method of claim 1 wherein step (g) further comprises the MSP paying an amount for Client's products and/or services ordered from the Client substantially the same as are paid by the public.

33. The method of claim 1 wherein step (g) further comprises the MSP paying an amount for Client's products and/or services ordered from the Client substantially the same as are paid by wholesaler and distributors.

34. A method of providing services to a Client, comprising:
a provider (P):
a) offering to obtain at least one of a product and a service to the Client in return for an agreed upon amount to be paid to P by the Client; and
b) purchasing at least one of the product and service in accordance with Client's approval;
the Client:
c) providing P the agreed upon amount per step (a);
P:
d) investing a given portion of the agreed upon amount with the Client;
the Client;
e) setting up an account on behalf of said P for the agreed upon amount per step (d);
the P:
f) remarketing as least one of Client's products and/or services; and
g) ordering at least one of Client's products and/or services from Client;
the Client:
h) debiting P's account by an amount of P's order.

35. The method of claim 34, wherein step (a) further comprises:
purchasing softgoods for Client.

36. The method of claim 34 wherein step (a) further comprises:
purchasing printing products on behalf of Client.

37. The method of claim 34 wherein step (c) further comprises paying the P the agreed upon amount in full.

38. The method of claim 34 wherein step (c) further comprises paying P the agreed upon amount in a series of partial payments.

39. The method of claim 38 wherein step (d) further comprises:
investing said given portion in partial investments, each partial investment being a given portion of each of Client's partial payments.
